(19) United States
(12) Patent Application Publication
(10) Pub. No.: US 2025/0355019 A1
(43) Pub. Date: Nov. 20, 2025

(54) ACCELEROMETER FOR REDUCED GRAVITY APPLICATIONS

(71) Applicant: Arizona Board of Regents on behalf of Arizona State University, Scottsdale, AZ (US)

(72) Inventors: Adam Pak, Mesa, AZ (US); Vincent Pizziconi, Tempe, AZ (US)

(21) Appl. No.: 18/860,945

(22) PCT Filed: Apr. 28, 2023
(86) PCT No.: PCT/US23/66356

§ 371 Date: Oct. 28, 2024

Related U.S. Application Data
(60) Provisional application No. 63/336,564, filed on Apr. 29, 2022.

(51) Int. Cl. G01P 15/03; G01P 1/02; G01P 1/08; G01P 15/14

(52) U.S. Cl. CPC G01P 15/038; G01P 1/023; G01P 1/08; G01P 15/14

(57) ABSTRACT

A corner flow accelerometer device for reduced gravity applications comprises a capillary tube, wherein the capillary tube is partially filled with a capillary fluid, and wherein the capillary tube includes at least one corner configured to enhance capillary flow. A corner flow accelerometer device for reduced gravity applications comprises a hollow square prism comprising a capillary tube, wherein the square prism is partially filled with a capillary fluid comprising silicone oil, and wherein the square prism is anchored to a weight inside a gyroscope body. A gravity monitoring method comprises providing the corner flow accelerometer device as describe above, measuring a fluid height or meniscus curvature due to capillary flow, calculating a dimensionless Bond number based on the measured fluid height or meniscus curvature, wherein the dimensionless Bond number comprises a ratio between gravitational and surface forces, and calculating a gravitational force based the Bond number.

### CROSS-REFERENCE TO RELATED APPLICATIONS

This application claims priority to U.S. provisional application No. 63/336,564 filed on Apr. 29, 2022, incorporated herein by reference in its entirety.

### BACKGROUND OF THE INVENTION

The quantitative measurement of the acceleration of gravity (g) has long been a matter of scientific interest in broad areas of the physical sciences involving metrology (the scientific study of measurement), geophysics (a branch of earth science dealing with the physical processes and phenomena occurring especially in the earth and in its vicinity) and geodesy (the science of measuring Earth's size, shape, rotation and orientation in space). In metrology, for example, as the value of g influences the measurement of force or of any physical quantity involving a standard force, such as, the ampere, pressure, among others, its accuracy influences the accuracy of the standard units in many metrological fields including mechanics, electricity, thermometry, fluid dynamics. On the other hand, geophysics and geodesy are mainly interested in variations in gravity which change with location and at a given location with time due to the Earth's spin, departures of its surface from an equipotential spheroid and density variations that occur within the Earth.

The plethora of gravity measurement devices that have been developed over the past several centuries in support of the growing field of geodetic metrology, generally known as gravimeters, are primarily based on how gravity interacts with mass. These include gravimeters that either function in absolute mode, such as, the use of falling bodies or the use a pendulum to determine g by measure of time (or period) and length, or in relative mode, such as, devices that use a mass-spring system whereby the force on the test mass changes with variations in the gravitational field, and these small changes in gravity are detected by noting the corresponding small variations in weight or by mass displacement. (see Marson, I. and J. E. Faller, g-the acceleration of gravity: its measurement and its importance 1986 J. Phys. E: Sci. Instrum. 19 22.)

Many versions of gravimeters have been developed to measure the strength of the gravity field, such as, inclined zero length spring design, that utilized metal and quartz springs, a virtual spring feedback design where magnetic levitation replaced the spring element, as well as gradiometers that measure the gradient or spatial rate of change of the components of the gravity field. (see Chapin, D., Gravity Instruments: Past, Present, Future, The Leading Edge, January 1998.)

As gravity measuring devices, such as absolute and relative gravimeters, rely on extensive properties of matter, i.e., mass, they have significant limitations and disadvantages. Gravimeters are relatively bulky and cumbersome, not easily transportable, require controlled temperature environments and expensive complex designs having intrinsic nonlinearities and tradeoffs that make highly accurate, precise and repeatable measurements of g under field conditions technically challenging and difficult to achieve. (see Krasnow, U.S. Pat. No. 2,303,845, 1942; Carter, W. E. et al, New Gravity Meter Improves Measurements, Eos, Vol. 75, No. 8, Feb. 22, 1994)

Thus, there is a need to develop new types of gravity measurement devices that can overcome many of the disadvantages of traditional gravimeters that primarily rely upon extensive properties of matter but instead rely upon intensive properties of matter that depend only on the type of matter in a sample and not on the amount of matter. These new types of gravity measurement instruments offer new capabilities and applications that extend well beyond those physical science areas that utilize conventional gravitational measurement systems and cross broad industrial sectors, basic and applied research and even health dosimetry needs. For example, a valuable condition both for microgravity acceleration environment research as noted by presence of active rack isolation systems onboard ISS and for private-sector manufacturing of materials such as fiber optics where reduction of material defects can drive profits back on earth. (see Volfson, L.; Starodubov, D. Fiber Optic Manufacturing in Space. US20170233282A1, Aug. 17, 2017) (see Dubbs, C. Realizing Tomorrow the Path to Private Spaceflight; Outward odyssey; University of Nebraska Press: Lincoln, 2011). Also, recent findings from studies conducted on astronauts exposed to microgravity for extended periods of time in space indicate that there is a dose-response relationship to exposure to extreme gravity environments which can benefit from new gravity dosimetry technologies. (see Trudel, G., et al, Characterizing the effect of exposure to microgravity on anemia: more space is worse, Am J Hematol. 2020; 95:267-273)

As current technology lacks design requirements needed for these applications, there is a need in the art for improved systems, devices, and methods that can exploit intensive properties of matter, such as, surface tension, among other intensive properties of matter, which provide the basis for novel gravity measurement technologies and applications, such as, corner flow accelerometry, for measurement of reduced gravity. (see Liu, Y-M et al, The Possibility of Changing the Wettability of Material Surface by Adjusting Gravity, AAAS Research Volume 2020, Article ID 2640834; Love, S. G., Particle Aggregation in Microgravity: Informal Experiments on the International Space Station, Meteroritics & Planetary Science 49 Nr 5, 732-739 (2014)

### SUMMARY OF THE INVENTION

Some embodiments of the invention disclosed herein are set forth below, and any combination of these embodiments (or portions thereof) may be made to define another embodiment.

Accordingly, the present invention is directed to improved gravity measurement methods, devices and systems that substantially obviates one of more limitations and disadvantages of related prior art.

In accordance with one or more embodiments of the present invention, there is provided an enclosed, bounded volume forming an interior lumen of finite dimension having at least one solid surface and containing at least one fluid or fluid suspension containing particles of which at least one element having an intrinsic material property responsive to gravity

In one aspect, a sealed capillary tube having a first end and a second end and a length therebetween, the capillary tube forming an interior lumen comprising at least one interior surface; wherein the capillary tube is partially filled with a capillary fluid; and wherein the capillary tube includes at least one corner running along at least a portion of the length at the edge of the at least one interior surface configured to enhance capillary flow.

In one embodiment, the at least one corner is at the intersection between two or more interior surfaces.

In one embodiment, the capillary tube is anchored to a weight inside a gyroscope body.

In one embodiment, the capillary tube is transparent or translucent.

In one embodiment, the interior surface comprises an indication surface.

In one embodiment, the device further comprises at least one wedge or fin affixed to the interior surface.

In one embodiment, the at least one corner is in the range of 1 to 1000 corners.

In one embodiment, the capillary tube comprises an n-gonal prism, a square prism, a rectangular prism, a triangular prism, a pentagonal prism, a hexagonal prism, an octagonal prism, a trapezoidal prism, or a polygonal prism.

In one embodiment, a cross-section of the lumen of the capillary tube comprises a square, rectangle, parallelogram, diamond, trapezoid, trapezium, rhombus, triangle, curvilinear triangle, tear drop, crescent, pentagon, or polygon.

In one embodiment, the capillary fluid comprises a polar liquid comprising water or ethanol, or a non-polar liquid comprising silicone oil.

In one embodiment, the capillary fluid comprises a volume of 1 pL to 1000 mL.

In one embodiment, the capillary tube comprises at least one of a ceramic with high intrinsic wetting characteristics, a glass ceramic that has tunable wetting characteristics, borosilicate glass, titanium dioxide, silica, a polymer with high intrinsic wetting characteristics, a polymer that has tunable wetting characteristics, acrylics, epoxies, polyethylene, polystyrene, polyvinylchloride, polytetrafluorethylene, polydimethylsiloxane, polyesters, and polyurethanes.

In one embodiment, the capillary tube has a length in the range of 1 μm to 50 m, a width in the range of 1 nm to 1 m, a height in the range of 1 nm to 1 m, and an interior volume in the range of 1 μL to 10 L.

In another aspect, a corner flow accelerometer system for reduced gravity applications comprises the corner flow accelerometer device as described above; at least one sensor proximate to the corner flow accelerometer device configured to measure a fluid height or meniscus curvature due to capillary flow in the corner flow accelerometer device; and a computing system communicatively connected to the at least one sensor, comprising a processor and a non-transitory computer-readable medium with instructions stored thereon, which when executed by the processor, perform steps comprising: calculating a dimensionless Bond number based on the measured fluid height or meniscus curvature, wherein the dimensionless Bond number comprises a ratio between gravitational and surface forces; and calculating a gravitational force based on the Bond number.

In one embodiment, the at least one sensor comprises an electrical or optical sensor.

In one embodiment, the system is configured to measure a gravitational acceleration force in the range of 0 g to 5 g (g=9.8 m/sec²).

In another aspect, a gravitational acceleration monitoring method comprises providing the corner flow accelerometer device as described above; measuring a fluid height or meniscus curvature due to capillary flow; calculating a dimensionless Bond number based on the measured fluid height or meniscus curvature, wherein the dimensionless Bond number comprises a ratio between gravitational and surface forces; and calculating a gravitational force based on the Bond number.

In one embodiment, the fluid height or meniscus curvature is measured via at least one sensor proximate to the corner flow accelerometer device.

In one embodiment, the at least one sensor comprises an electrical or optical sensor.

In one embodiment, the Bond number is defined by

$${B}_{0} = \frac{ρ {gH}^{2}}{σ} ,$$

where ρ is the density, g is the gravitational acceleration, H is the characteristic meniscus height, and σ is the surface tension. For values of B₀<1, surface energy forces dominate over gravitational forces whereas for values of B₀>1, gravitational forces dominate over surface energy forces. For values of B₀^{˜}1, surface energy forces and gravitational forces are approximately equal.

In another aspect a corner flow accelerometer device for reduced gravity applications comprises a hollow square or rectangular prism comprising a capillary tube, wherein the prism is partially filled with a capillary fluid comprising silicone oil, and wherein the prism is anchored to a weight inside a gyroscope body.

In another aspect, an accelerometer device for reduced gravity applications comprises an enclosed bounded volume forming an interior lumen having at least one solid surface; at least one fluid within the lumen; wherein the fluid includes particles in suspension; and wherein a least one of the fluid and particles in suspension possess an intrinsic material property responsive to gravity.

In one embodiment, the intrinsic material property responsive to gravity is surface energy in nature.

In one embodiment, the intrinsic material property responsive to gravity is electrostatic in nature.

In one embodiment, the solid, fluid and/or the suspension materials that form the gravity measurement system are dielectric in nature and the fluid contains particles of size range where surface-dominated electrostatic forces are greater than mass-proportional inertial forces favoring particle aggregation in proportion to reduced gravity environments.

In one embodiment, the suspension is comprised of dielectric particles comprised of semiconducting quantum dot materials of nanoscale dimension whereby particle aggregation in reduced gravity environments promotes quenching of quantum dot photoluminescence.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements, and in which:

FIG. 1A shows an exemplary capillary-based corner flow accelerometer device for reduced gravity applications in accordance with some embodiments.

FIG. 1B shows exemplary cross sections of the device in accordance with some embodiments. (see Weislogel M M. Compound capillary rise. Journal of Fluid Mechanics. 2012 October; 709:622-47.)

FIG. 2 is a plot showing general capillary characteristic geometric response (H) dependance on gravity in accordance with some embodiments.

FIG. 3 is a plot of experimental results showing that corners provide a pronounced response relative to classic capillary action in accordance with some embodiments.

FIG. 4 is a plot of experimental results showing corner driving force geometrical dependence in accordance with some embodiments.

FIG. 5 depicts an exemplary computing environment in which aspects of the invention may be practiced in accordance with some embodiments.

### DETAILED DESCRIPTION OF THE INVENTION

It is to be understood that the figures and descriptions of the present invention have been simplified to illustrate elements that are relevant for a clearer comprehension of the present invention, while eliminating, for the purpose of clarity, many other elements found in systems and methods of corner flow accelerometer for reduced gravity applications. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of +20%, +10%, +5%, +1%, and +0.1% from the specified value, as such variations are appropriate.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Nomenclature as used herein is defined in Table 1 below:

TABLE 1

| | | |
|---|---|---|
| θ | ° | contact angle |
| α | ° | corner half-angle |
| κ | | capillary length |
| r | | tube radius |
| γ | | surface tension |
| ρ | | density |
| g | | gravitational acceleration |
| D | | channel width |
| μ | η | viscosity (dynamic)(classic) |
| V_{b} | | bubble velocity |
| σ | γ | surface tension (interfacial tension) |
| P | | pressure |
| ψ | | dimensionless local flow coefficient |
| Rₛ | | bubble radius |
| Rₛₒₒ | | asymptotic bubble radius |
| H | | characteristic interfacial dimension along x-axis |
| | | characteristic meniscus height |
| L | | characteristic interfacial dimension along z-axis |
| | | characteristic length of fluid column |
| | | or cell length |
| ϵ | | slenderness ratio |
| H | | average meniscus curvature |
| x | | coordinate along x-axis |
| y | | coordinate along y-axis |
| yₘ | | contact line coordinate along y-axis |
| z | | coordinate along z-axis |
| [symbol] | | tip location |
| S | | surface elevation |
| h | | meniscus heigh from x-axis |
| u | | velocity along x-axis |
| v | | velocity along y-axis |
| < w > | | velocity averaged over area along z-axis |
| w | | velocity along z-axis |
| W | | characteristic velocity |
| f | | surface curvature function |
| t | | time |
| A | | cross sectional flow area |
| \dot{Q} | | volumetric flow |
| Su | | Suratman number |
| Oh | | Ohnesorge number |
| Bo | | Bond number |
| Ca | | |
| Rₑ | | Reynold number |
| F_{A} | | liquid column cross sectional area |
| Fᵢ | | banded flow resistance |
| β | | dimensionless flow resistance |
| K | | dimensionless friction factor |

In one embodiment, capillary flow accelerometer discussed herein is ideal to fill a demand for a low-cost support device that is easy to interpret with sight. Similar to how spirit leveler fulfills their purpose here on earth.

$${γ}_{S} = {γ}_{S L} + {γ}_{L} cos θ \qquad ( 1 )$$

In 1805 Thomas Young introduced Equation 1 that described contact angle (θ) resulting from balance of forces given by the three phases that meet at a point where surface tensions of solid-vapor, solid-liquid and liquid-vapor are described by γ_{S}, γ_{SL} and γ_{L} respectively. Although elegant, Equation 1 sparked debate and this balance of forces has been revisited from a point of view of minimization of energy and thermodynamic lens of treating surface tension as surface energy.

Debate has not subsided as recent scientific progress in nano scale studies scrutinizes the very validity of Young's equation. (see Hawa, T., et al., Internal Pressure and Surface Tension of Bare and Hydrogen Coated Silicon Nanoparticles. The Journal of chemical physics 2004, 121 (18)) (see Wang, E. N., et al., Uni-Directional Liquid Spreading on Asymmetric Nanostructured Surfaces. Nature materials 2010, 9 (5), 413-417) (see Demirel, M. C., et al., An Engineered Anisotropic Nanofilm with Unidirectional Wetting Properties. Nature materials 2010, 9 (12), 1023-1028) (see Liu, Y., et al., Contact Line Pinning and the Relationship between Nanobubbles and Substrates. J. Chem. Phys. 2014, 140 (5), 054705)

Specifically on the issue of relation between gravity and Young's contact angle, it has been found through microgravity experimentation in both drop tower and parabolic arc flights that gravity in fact does have significant contributions to contact angle down to liquid drops of 5 μL. (see Ababneh, A., et al., Effect of Gravity on the Macroscopic Advancing Contact Angle of Sessile Drops. The Canadian Journal of Chemical Engineering 2006, 84 (1), 39-43) (see Diana, A., et al., Sessile Drop Wettability in Normal and Reduced Gravity. Microgravity Sci. Technol. 2012, 24 (3), 195-202) (see Zhu, Z.-Q., et al., Influence of Bond Number on Behaviors of Liquid Drops Deposited onto Solid Substrates. Microgravity Sci. Technol. 2012, 24 (3), 181-188) (see Calvimontes, A. The Measurement of the Surface Energy of Solids by Sessile Drop Accelerometry. Microgravity Sci. Technol. 2018, 30 (3), 277-293)

Through analytical small-slope solution it has been shown that gravity cannot be neglected when \sqrt{B₀}>1 even for sessile drops as small as 1 μL. (see Calvimontes) (see Allen, J. S. An Analytical Solution for Determination of Small Contact Angles from Sessile Drops of Arbitrary Size. Journal of Colloid and Interface Science 2003, 261 (2), 481-489) So contact angle does depend on gravity, but the effect is insignificant from perspective of human sight to directly exploit the relationship for indication. When conversation is extended from contact point to contact line, it too is difficult to utilize reliably for both physical and practical reasons. Physically due to stress singularity at the moving contact line that is poorly known, which would result in design metrics relying more on empirical data. (see Kistler, S. F. Hydrodynamics of wetting. In Wettability (ed. J. C. Berg), Surfactant Science Series 1993, vol. 49, 311-429) (see Dussan, E. B. On the Spreading of Liquids on Solid Surfaces: Static and Dynamic Contact Lines. Annual review of fluid mechanics 1979, 11 (1), 371-400) (see Hu, X. Y., et al., Moving Contact Line with Balanced Stress Singularities. arXiv:0806.3847 [physics] 2008)

Practically to apply moving contact line knowledge conditions of smooth, flat, and chemically homogenous surface would have to be upheld throughout accelerometers life, placing undue burden on both manufacturer and user. (see Sheng, Y.-J., et al., Effects of Geometrical Characteristics of Surface Roughness on Droplet Wetting. J. Chem. Phys. 2007, 127 (23), 234704) To overcome those hurdles disclosed herein is a material system that completely wets the interior of indicating surface, a condition of θ=0 in Equation 1, allowing to overlook stress singularity and contact line pinning related calculations, practically making indication surface less vulnerable to corrosion over its lifetime, and allowing cheap chemically heterogenous materials to be used.

It is helpful to identify potential source(s) of force that can balance gravity to provide an equilibrium state that can be interpreted as indication. Some of these sources of forces that can be used to balance with gravity include, but are not limited to, the van der Waals interaction comprising s short-ranged electromagnetics force between molecules and/or atoms and which has neutral charge only, an overlap of electric double layer comprising electrical interaction by the overlap of electric double layer around a particle in solution, a steric interaction of absorbed polymer comprising a short-ranged interaction by the overlap of an absorbed polymer layer on particles, a ridge force comprising formation of the bridge of a polymer binder and/or surfactant between particles, a hydration force comprising an overlap of hydrogen-bonded water molecules on a hydrophilic surface on particle, an depletion comprising negative absorption of solute and polymer by having less affinity for the surface than the solvent. (see Hosokawa M, Naito M, Nogi K, Yokoyama T. Nanoparticle Technology Handbook [Internet]. Saint Louis, NETHERLANDS, THE: Elsevier; 2012)

Fundamental categories of possible mechanisms for indication and some examples are presented in Table 2 below. Those categories have potential to be utilized by themselves for indication, but it is most likely that the most ideal solution includes a combination of those categories. For example, while remainder of this disclosure will focus on interior surfaces alone as the solution, an improved indication can be achieved with inclusion of quantum dots floating in liquid that fills the corner. In such scenario quantum dots would provide visual feedback for indication and introduce additional surface forces and mass available for the system to be utilized, and additional phenomenon that can be used for measurement purposes such as electrostatic agglomeration. While Table 2 categories can be explicitly mixed and matched in search of solution, it should be also noted that some of the categories already inherently adopt multiple mechanisms and therefore may not be straight forward to implement. For example, graviperception in biology can utilize mechanical membrane strain as stimuli for membrane ion transport that provides an indication to the cell. Right away it can be observed that in both examples of quantum dot addition to corner flow and/or biological cell membrane utilization presents challenge of complexity. An increase of complexity in turn makes it more difficult to theoretically map out the compounded mechanism. When faced with such difficulty a solution typically may rely more on empirical approach, which is not conducive to adaptive design as empirical approaches also come with their scalability limits.

TABLE 2
Potential fundamental approaches for gravity indication

| | |
|---|---|
| Mechanical | Spring, ceramic, quartz, & MEMS |
| Electromagnetic | Superconductive materials, electrostatic |
| | suspension, magnetic fluid |
| Thermodynamic/ | Temperature controlled surface tension, phase |
| Kinetic/Static | separation, density gradients (sedimentation) |
| Surface | Wetting, capillary, particles |
| Quantum | atom Interferometry, phonons in zero-temperature |
| | superfluid |
| Optical | Pressure sensitive materials, reflective glancing |
| | angle deposited films, |
| Biological | graviperception in flagellates & plants, membrane |
| | ion channels, cyto & exo-skeleton adaptations |

Ideal systems are sensitive, adaptive, work in real time, robust, have long life, are inexpensive, need no upkeep, and are simple. Mechanical gravity monitoring systems include ceramic, quartz, spring, and MEMS. Electromagnetism gravity monitoring systems include superconductive material, levitation, magnetic fluid, cold atom interferometer, Piezoresistive, and superconductive materials. Thermo/Static/Kinetic gravity monitoring systems include temp controlled surface tension, phase separation, and sedimentation. Interior Surface gravity monitoring systems include wetting and capillary applications. Exterior Surface gravity monitoring systems include particles. Quantum gravity monitoring systems include atom Interferometry, and phonons in zero-temperature superfluids. Optical gravity monitoring systems include pressure sensitive materials and reflective glancing angle deposited films. Biological gravity monitoring systems include graviperception in flagellates and plants, membrane ion channels, and cyto-skeleton and exo-skeleton adaptations.

Interior surface gravity monitoring systems fulfill the requirements of being sensitive, being adaptive, working in real time, being robust, having long life, being inexpensive, needing no upkeep, and being simple.

Mechanical spring accelerometers where a reference mass is connected via spring is perhaps most intuitive example to start with. Its theoretically simple and an already proven concept that is materialized in the example of Italian Spring Accelerometer (ISA). Its high accuracy, that can reach up to 3×10⁻⁸ (m/s²), is showcased by its ability of characterization of exoplanets interiors through gravitational anomalies. (see Santoli, F., et al., ISA, a High Sensitivity Accelerometer in the Interplanetary Space. Space Sci Rev 2020, 216 (8), 145)

While prior work is diverse, historically a numerical approach is highlighted in regards to capillary flow to draw contrast to less numerically intensive methods presented by Weislogel. (see Weislogel, M. M.; Ross, H. D. Surface Settling in Partially Filled Containers upon Step Reduction in Gravity, 1990) Fundamentals for capillary flow in corners at negligible gravity has been built by P. S. Ayyaswamy et al. by studying laminar flow in grooves and solving for friction factor coefficient. (see Ayyaswamy, P. S., et al., Capillary Flow in Triangular Grooves. Journal of Applied Mechanics 1974, 41 (2), 332-336) Building on Ayyaswamy work, Dong et al. explored capillary rise at corners as a function of liquid viscosity, surface tension, contact angle, overall tube size and roundness of corner. (see Dong, M., et al., The Imbibition and Flow of a Wetting Liquid along the Corners of a Square Capillary Tube. Journal of Colloid and Interface Science 1995, 172 (2), 278-288) Noncircular porosity flow studies also contributed, notably to nondimensional flow resistance quantification done by Ransohoff and Radke through applying Galerkin finite elements numerical technique, resulting in values similar in application as friction factor. (see Ransohoff, T. C., et al., Laminar Flow of a Wetting Liquid along the Corners of a Predominantly Gas-Occupied Noncircular Pore. Journal of Colloid and Interface Science 1988, 121 (2), 392-401) Impact of this early study is demonstrated by flow resistance value application in the reverse case of gas bubbles rising in angular column filled with liquid as studied by Bico and Quéré. (see Bico, J. et al., Rise of Liquids and Bubbles in Angular Capillary Tubes. Journal of Colloid and Interface Science 2002, 247 (1), 162-166) Another noncircular pore study which also utilized flow resistance values was done by A. R. Kovscek et al. where gravity is included in derivation as a simple pressure gradient imposing term. (see Kovscek, A. R., et al., Gas Bubble Snap-off under Pressure-Driven Flow in Constricted Noncircular Capillaries. Colloids and Surfaces A: Physicochemical and Engineering Aspects 1996, 117 (1), 55-76)

Finally thesis work by Weislogel laid the foundation of corner rise in absence of gravity in 1996 that is applied in this disclosure. (see Weislogel, M. M. Capillary Flow in an Interior Corner, NASA Technical Memorandum 107364, 1996) Additional follow-up contributions to the model came from Weislogel and Litcher in 1998 then by Rame and Weislogel in 2009. (see Weislogel, M. M.; Lichter, S. Capillary Flow in an Interior Corner. Journal of Fluid Mechanics 1998, 373, 349-378) (see Rame, E.; Weislogel, M. M. Gravity Effects on Capillary Flows in Sharp Corners. Physics of Fluids 2009, 21 (4), 042106) Producing a closed form dimensionless expressions solutions for liquid column tip location and velocity. Those solutions, particularly those concerning constant volume, can be directly adopted for indication in negligible gravity.

Referring now in detail to the drawings, in which like reference numerals indicate like parts or elements throughout the several views, in various embodiments, presented herein are systems and methods of corner flow accelerometer for reduced gravity applications.

In accordance with one or more embodiments of the present invention, there is provided an enclosed, bounded volume forming an interior lumen of finite dimension having at least one solid surface and a lumen containing at least one fluid or fluid suspension comprised of particles of which at least one material element possessing an intrinsic material property responsive to gravity.

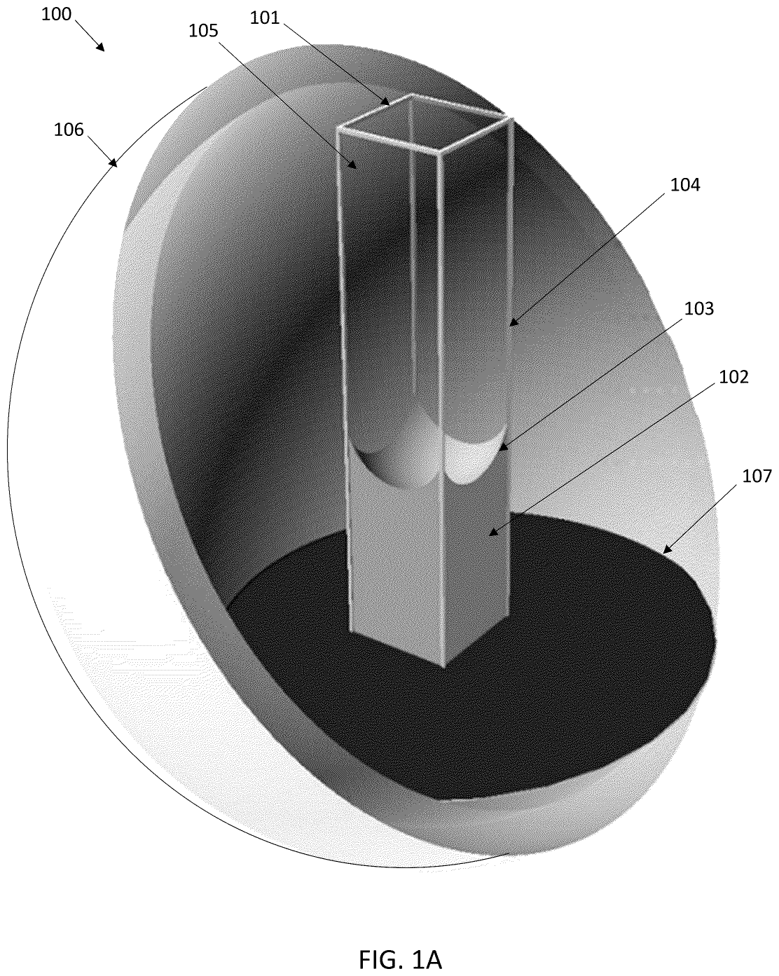

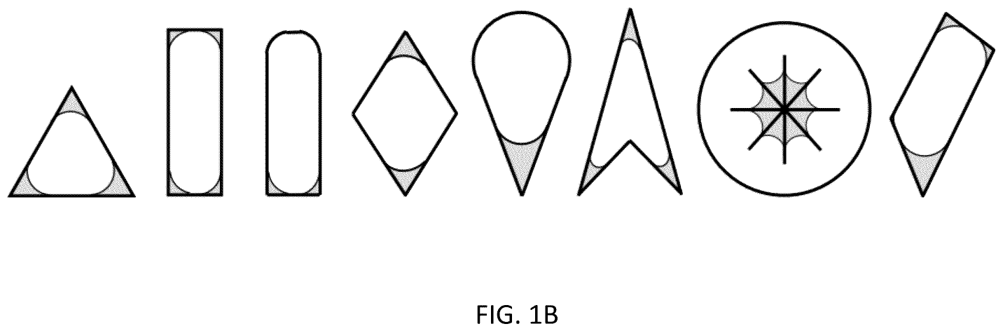

FIGS. 1A-1B shows an exemplary capillary-based corner flow accelerometer device 100 for reduced gravity applications in accordance with some embodiments. An exemplary design for a corner flow accelerometer comprising a capillary tube 101 (e.g. number of corners N=4 or similar) (e.g. acrylic or similar) partially filled with a liquid 102 (e.g. silicone oil or similar), but any suitable shape, volume, and/or number of corners N 104 may be utilized. In some embodiments, the capillary tube 101 is anchored to an optional weight 107 that is inside an optional gyroscope body 106 is shown and configured to align the capillary tube 101 with a nearby gravitational center. The capillary tube 101 inside the gyroscope body 106 can be configured similar to a floating compass, where the capillary tube 101 is positioned internal to a gyroscope body 106. The gyroscope body 106 can be any suitable type including a classic gyroscope body with 3 circular frames and 3 sets of hinges, a compass-like gyroscope as shown in FIG. 1A, and/or a sphere filled with liquid. In some embodiments, friction in the hinges of the gyroscope needs to be proportionally weak compared to the weight of the liquid and the force of gravity desired to be detected. As used herein, “corner” and “edge” are utilized interchangeably for describing embodiments of corner flow accelerometer devices where edge may be used to describe the shape of the device, and corner may be used to describe the interior portion of the shape edge where increased capillary action takes place.

In some embodiments, a corner flow accelerometer device 100 for reduced gravity applications comprises a sealed capillary tube 101 having a first end and a second end and a length therebetween, the capillary tube 101 forming an interior lumen comprising at least one interior surface 105, where the capillary tube 101 is partially filled with a capillary fluid 102, and where the capillary tube 101 includes at least one corner 104 running along at least a portion of the length at the edge of the at least one interior surface 105 configured to enhance capillary flow 103.

In some embodiments, the at least one corner 104 is at the intersection between two or more interior surfaces 105. In some embodiments, the capillary tube 101 is anchored to a weight inside a gyroscope body. In some embodiments, the capillary tube 101 is transparent or translucent. In some embodiments, the interior surface 105 comprises an indication surface. In some embodiments, the device 100 further includes at least one wedge or fin affixed to the interior surface 105. In some embodiments, the at least one corner 104 is in the range of 1 to 1000 corners.

In some embodiments, the capillary tube 101 comprises an n-gonal prism, a square prism, a rectangular prism, a triangular prism, a pentagonal prism, a hexagonal prism, an octagonal prism, a trapezoidal prism, or a polygonal prism, any enclosed bounded volume, or any other suitable shape or combination thereof. In some embodiments, the capillary tube 101 comprises a cylinder or sphere with triangulated walls. In some embodiments, the capillary tube 101 comprises a sphere with ribbed or wedged walls. In some embodiments, the capillary tube 101 includes rounded and/or sharp corners. (see Tang Y, Yue B, Yan Y. Improved method for implementing contact angle condition in simulation of liquid sloshing under microgravity. International Journal for Numerical Methods in Fluids. 2019; 89 (4-5): 123-42) In some embodiments, the capillary tube 101 includes a wedged surface. In some embodiments, a cross-section of the lumen of the capillary tube 101 comprises a square, rectangle, parallelogram, diamond, trapezoid, trapezium, rhombus, triangle, curvilinear triangle, tear drop, crescent, pentagon, polygon, or any other suitable shape or combination thereof. Further exemplary cross sections are shown in FIG. 1B and examples are detailed in Weislogel et al. (see Weislogel MM. Compound capillary rise. Journal of Fluid Mechanics. 2012 October; 709:622-47) In some embodiments, the capillary tube 101 is comprised of ceramics with high intrinsic wetting characteristics, glass ceramics that have tunable wetting characteristics (contact angle <90 degrees) (e.g. borosilicate glass, titanium dioxide, silica, among others), polymers with high intrinsic wetting characteristics, or polymers that have tunable wetting characteristics (contact angle <90 degrees) (e.g. acrylics, epoxies, polyethylene, polystyrene, polyvinylchloride, polytetrafluorethylene, polydimethylsiloxane, polyesters, and polyurethanes), among others. In some embodiments, the capillary tube has a length in the range of 1 μm to 50 m, a width in the range of 1 nm to 1 m, a height in the range of 1 nm to 1 m, and an interior volume in the range of 1 μL to 10 L.

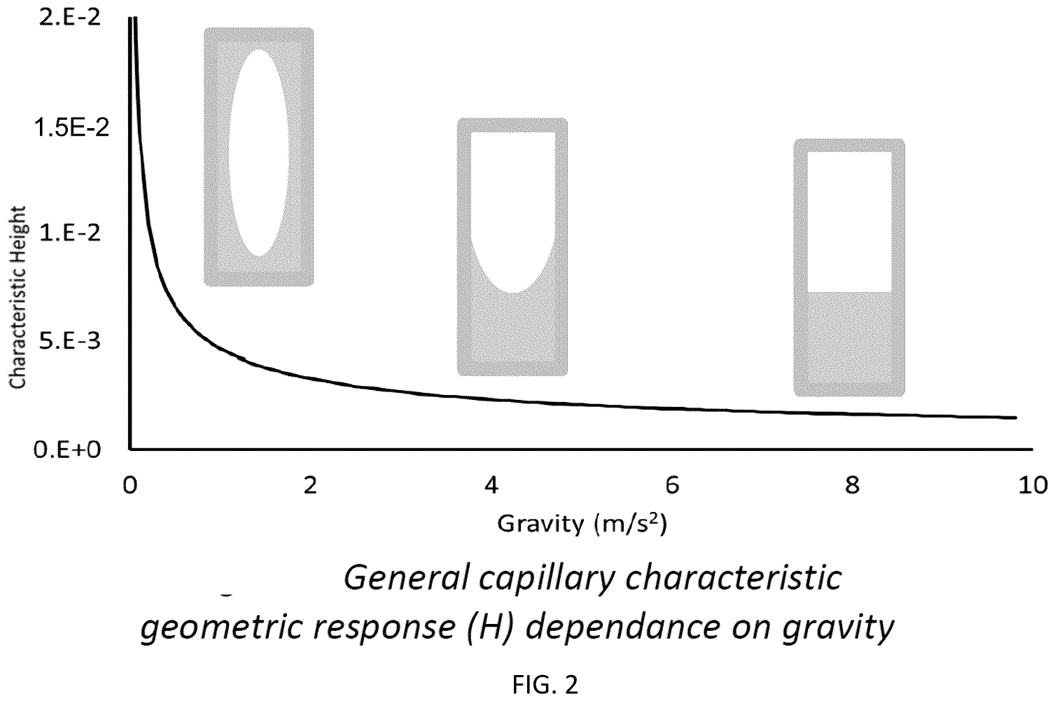

In some embodiments, the capillary tube 101 comprises a sphere enclosed volume with a wedged wall and/or a wall divided into flat surfaces with corners between them. This is a 3D shape which can indicate gravity without the need for a gyroscope body. Similar to what is shown in FIG. 2 where the liquid climbs along the corners at reduced gravitational acceleration, the same principle applies for a sphere where the air bubble would move increasingly away from the walls under reduction in gravitational acceleration. (see Tang Y, Yue B, Yan Y. Improved method for implementing contact angle condition in simulation of liquid sloshing under microgravity. International Journal for Numerical Methods in Fluids. 2019; 89 (4-5): 123-42.) (see [Veldman A E P, Gerrits J, Luppes R, Helder J A, Vreeburg J P B. The numerical simulation of liquid sloshing on board spacecraft. J Comput Phys. 2007; 224 (1): 82-99.) Note that in the case of contact angle of 0 (θ=0, totally wetted surface) a liquid drop will spread indefinitely along a rounded or sharp interior corner. (see Chen Y, Weislogel M M, Nardin C L. Capillary-driven flows along rounded interior corners. Journal of Fluid Mechanics. 2006 November; 566:235-71.) In an enclosed volume a floating surface that doesn't make an angle with a wall can be used as the space of minimal distance between a floating surface and a vessel wall that's climbed by liquid. (see Weislogel M M, Jenson R, Chen Y, Collicott S H, Klatte J, Dreyer M. The capillary flow experiments aboard the International Space Station: Status. Acta Astronautica. 2009 September; 65 (5-6): 861-9.]) An example of a floating surface assisting in indication of micro gravity can be seen in Weislogel at al. In some embodiments, a floating wall and/or a floating shape such as sphere or a polygon is included. Examples include a tapered rectangular vessel (see Weislogel M M, Jenson R, Chen Y, Collicott S H, Klatte J, Dreyer M. The capillary flow experiments aboard the International Space Station: Status. Acta Astronautica. 2009 September; 65 (5-6): 861-9.), n-regular polygons, rectangles, combined rounded rectangles, selective but equal-edge wetted sections, sharp and round corner combinations, re-entrant sections, vane structures, and/or irregular polygons. (see Weislogel MM. Compound capillary rise. Journal of Fluid Mechanics. 2012 October; 709:622-47.)

In some embodiments, the capillary fluid 102 is comprised of either polar liquids, (e.g. water, ethanol), or non-polar liquids (e.g. silicone oil). In some embodiments, the capillary fluid comprises a volume of 1 μL to 10 L. In some embodiments, the capillary fluid comprises a volume of 1 pL to 10 ML. In some embodiments, the capillary tube 101 and capillary fluid 102 comprise any suitable combination of solid and liquid that produce a wetted surface.

In some embodiments, a corner flow accelerometer system for reduced gravity applications comprises the corner flow accelerometer device 100 as described above; at least one sensor proximate to the corner flow accelerometer device configured to measure a fluid height or meniscus curvature due to capillary flow in the corner flow accelerometer device 100; and a computing system communicatively connected to the at least one sensor, comprising a processor and a non-transitory computer-readable medium with instructions stored thereon, which when executed by the processor, perform steps comprising: calculating a dimensionless Bond number based on the measured fluid height or meniscus curvature, wherein the dimensionless Bond number comprises a ratio between gravitational and surface forces; and calculating a gravitational force based on the Bond number. In some embodiments, the at least one sensor comprises an electrical or optical sensor. In some embodiments, the system is configured to measure a gravitational acceleration force in the range of 0 g to 5 g (g=9.8 m/sec²).

In some embodiments, a gravitational acceleration monitoring method comprises providing the corner flow accelerometer device 100 as described above; measuring a fluid height or meniscus curvature due to capillary flow; calculating a dimensionless Bond number based on the measured fluid height or meniscus curvature, wherein the dimensionless Bond number comprises a ratio between gravitational and surface forces; and calculating a gravitational force based on the Bond number. In some embodiments, the fluid height or meniscus curvature is measured via at least one sensor proximate to the corner flow accelerometer device 100. In some embodiments, the at least one sensor comprises an electrical or optical sensor.

In some embodiments, the Bond number is defined by

$${B}_{0} = \frac{ρ {gH}^{2}}{σ} ,$$

where ρ is the density, g is the gravitational acceleration, H is the characteristic meniscus height, and σ is the surface tension. In some embodiments the Bond number based on surface curvature is defined by

$${B}_{0 H} = \frac{f ρ {gH}^{2}}{σ} ,$$

where ƒ is the surface curvature function, ρ is the density, g is the gravitational acceleration, H is the characteristic meniscus height, and σ is the surface tension. In some embodiments the Bond number based on curvature and column length is defined by

$${B}_{0 H ℒ} = \frac{f ρ gH ℒ}{σ} ,$$

where ƒ is the surface curvature function, [symbol] is the tip location [symbol] (t), ρ is the density, g is the gravitational acceleration, H is the characteristic meniscus height, and σ is the surface tension.

In some embodiments, the one can adjust the Bond number of the system to tune it to appropriate acceleration range. A large Bond number (Bₒ>1) would configure the system to indicate a high gravity as characterized by flat liquid surface (e.g. low curvature of liquid surface) and minimal climb onto the corner, while small Bond number (Bₒ<1) would result in liquid climbing the corners (e.g. low curvature of liquid surface). Variables such as surface tension and characteristic length can be chosen such that at working gravitational acceleration force Bₒ^{˜}1, giving opportunity for the ratio to become either greater than or less than 1 during gravitational force fluctuations. In some embodiments, to arrive at a desired Bond number, once can choose gravitational environment (g) and a size (H), and look up inn a material library to choose a preferred surface tension of liquid, and then choose a solid material that can be perfectly wetted by liquid.

Corners 104 allow for pronounced capillary flow 103 at the solid surface and possess dimensionless closed formed solutions for perfectly wetted (θ=0) cases which are applied to create a map for adaptive designs. The governing equation (Equation 2) below captures height, time, and friction components. (see Weislogel, M. M. Capillary Flow in an Interior Corner, 1996)

$$\frac{\partial h}{\partial t} = {F}_{i} ( {( \frac{\partial h}{\partial t} )}^{2} + \frac{h}{2} \frac{{\partial }^{2} h}{\partial {z}^{2}} ) \qquad ( 2 )$$

The dimensionless Bond number is the ratio between gravitational to surface forces at play, which can be incorporated directly into Equation 2 above as:

$${B}_{0} = \frac{ρ {gH}^{2}}{σ} , \frac{\partial h}{\partial τ} = 2 {( \frac{\partial h}{\partial z} )}^{2} ( 1 + {B}_{0} {h}^{2} ) + h \frac{{\partial }^{2} h}{\partial {z}^{2}} ( 1 + {B}_{0} {h}^{2} ) \qquad ( 3 )$$

In some embodiments, moving from g to μg changes the acceleration induction as it reaches its new equilibrium position in 0.25s for a case of α=30°, D=22.6 mm, and μ=2 cS design. Liquid length can be readily predicted by:

$$L ( t ) = 1.9 {{F}_{A}^{- 1 / 5} ( γ {F}_{i} {sin}^{2} ( α ) / μ f )}^{2 / 5} {H}^{3 / 5} {t}^{2 / 5} \qquad ( 4 )$$

Meniscus curvature is the driving force for liquid height (h′) rise which can be adjusted geometrically through changing number of sides (N) of the tube: (see Weislogel 1998)

$${H}_{N - poly} = \frac{D}{2 f} \frac{sin ( α + δ )}{{F}_{\overline{A}}} [ 1 - \sqrt{1 - \frac{{F}_{\overline{A}} cot ( π / N )}{{sin}^{2} ( α + δ )}} ] \qquad ( 5 )$$

To easily understand how a capillary flow accelerometer 100 would work, one can deposit water into a square or rectangular container with hydrophilic surfaces. While most of the meniscus will be flat as gravitational forces dominate (Bo>>1), one can view the edges to see the curvature of the meniscus increase to accommodate the contact angle condition. When those edges meet at a corner 104 an increased influence of surface tension is seen as curvature further increases resulting in a liquid tip 103 being higher than the flat meniscus and liquid along the edges. This can be interpreted as contact angle enforced pressure gradient through a curvature of meniscus that is balanced by hydrostatic pressure. If this tabletop exercise was then taken into reduced gravity environment the balance provided by hydrostatic pressure would be decreased and liquid be allowed to climb the corner 104 further. Concus and Finn addressed mathematically those large capillary flows of interior corners. (see Concus, P.; Finn, R. On the behavior of a capillary surface in a wedge. Proc Natl Acad Sci USA 1969, 63 (2), 292-299) For a surface bounded by contact angle to exist it must fulfill conditions in Equation 6 otherwise the surface becomes unbounded or simply fails to exist. (see Concus, P.; Finn, R. On Capillary Free Surfaces in a Gravitational Field. Acta Mathematica 1974, 132 (none), 207-223) (see Concus, P.; Finn, R. On Capillary Free Surfaces in the Absence of Gravity. Acta Mathematica 1974, 132 (none), 177-198)

$$θ < π / 2 - α \qquad ( 6 )$$

Where θ is the contact angle and a corner half angle. It will be referred to as Concus-Finn condition which places the first requirement for corner geometry. It is a goal of this disclosure to provide a reader with general conditions and dimensionless parameters to create a road map for designs of capillary flow accelerometers that fulfils their needs, for example to provide indication for a specific range of gravitational accelerations. As shown below, an indicator made for Earth's surface usage would incorporate geometry with small a, in order to provide sufficient capillary force. While if the same material system would be used in Earth's orbit, a could be chosen to be higher as a smaller capillary force would be necessary to balance with hydrostatic pressure. (see Dong)

To provide the reader with general design requirements, dimensionless governing equations laid out by Weislogel in his initial doctorate thesis and subsequent follow-up with Lichter are used. (see Weislogel 1998) (see Weislogel 1996) His work then extends from sharp to rounded corner geometries and how they relate to capillary flow in microgravity conditions. (see Ramé) (see Weislogel, M. M. Capillary Flow in Interior Corners: The Infinite Column. Physics of Fluids 2001, 13 (11), 3101-3107) (see Chen, Y., et al., Capillary-Driven Flows along Rounded Interior Corners. Journal of Fluid Mechanics 2006, 566, 235-271) Furthermore geometries such as polygonal and compound flows are addressed where a system can be compromised of multiple wedges. (see Weislogel, M. Capillary Flow in Containers of Polygonal Section: Theory and Experiment. Theory and Experiment 2001, 26) (see Weislogel, M. M. Compound Capillary Rise. Journal of Fluid Mechanics 2012, 709, 622-647) With such complex geometries numerical data on friction factor is typically needed. To lower dependence on such data a nondimensionalization scheme is included in his work. (see Weislogel, M. M.; Chen, Y.; Bolleddula, D. A Better Nondimensionalization Scheme for Slender Laminar Flows: The Laplacian Operator Scaling Method. Physics of Fluids 2008, 20 (9), 093602) Most importantly his derivations are checked against experiments conducted in microgravity environments, as that would be the environment where a capillary flow accelerometer may be designed for. (see Concus, P.; Finn, R.; Weislogel, M. Measurement of Critical Contact Angle in a Microgravity Space Experiment. Experiments in Fluids 2000, 28 (3), 197-205) Pressure gradient along the corner is established in the wetting liquid due to increasing interface curvature. (see Weislogel 1996)

Interior corner flow draws its foundation from related studies of wedges, edges, grooves, and pores capillary flow in microgravity. (see Kovscek, A. R.; Radke, C. J. Gas Bubble Snap-off under Pressure-Driven Flow in Constricted Noncircular Capillaries. Colloids and Surfaces A: Physicochemical and Engineering Aspects 1996, 117 (1), 55-76) (see Concus, P. & Finn, R. 1990 Capillary surfaces in microgravity. In Low-Gravity Fluid Dynamics and Transport Phenomena. (ed. J. N. Koster & R. L. Sani) (see Progress in Astronautics and Aeronautics, Vol. 130, pp. 183-204. AIAA) (see Mason, G. & Morrow, N. 1991 Capillary behavior of a perfectly wetting liquid in irregular triangular tubes. J. Colloid Interface Sci. 141, 262-274) (see Langbein, D. 1990 The shape and stability of liquid menisci at solid edges. J. Fluid Mech. 213, 251-265) (see Wong, H., Morris, S. & Radke, C. J. 1992 Three-dimensional menisci in polygonal capillaries. J. Colloid Interface Sci. 148, 317-336)

Early work set up an approach to solving capillary problems but was only applicable to small containers with slow flows as assumptions of parallel flow as well as negligible inertia and streamwise curvature were applied. (see Ransohoff 1988) (see Ransohoff, T. C., Gauglitz, P. A. & Radke, C. J. 1987 Snap-off of gas bubbles in smoothly constricted noncircular capillaries. AIChE J. 33, 753-765) With introduction of dimensionless Bond (Bo) and Suratmen (Su) numbers, that are ratios of gravitational to surface tension and surface tension to inertia respectively, directly challenge those early assumptions:

$$Bo = \frac{ρ {gH}^{2}}{σ} \qquad ( 7 )$$

$$Su = \frac{ρ σ H}{{μ}^{2}} = {Oh}^{- 2} \qquad ( 8 )$$

Where μ is dynamic viscosity, ρ is density, σ surface tension, H is characteristic interfacial dimension, and g is gravitational acceleration. One may think of Su as Reynold's number for capillaries, where σ/μ is capillary velocity. (see Ramé) To keep significant capillary force presence in the system, its characteristic interfacial dimension should scale with capillary length, H≲κ While pressure scaling is done with a ratio of surface tension to characteristic interfacial dimension and xy-plane curvature function (ƒ). (see Weislogel 1996) When applied to microgravity, Su scales 10³ relative to earth surface gravity. (see Dong, M. & Chatzis, I. 1995 The imbibition and flow of a wetting liquid along the corners of a square capillary tube. J. Colloid Interface Sci. 172, 278-288) Taking that result into viscous time scale (t_{viscous}˜ρH/μ) a 10⁶ increase is expected relative to its earth surface gravity counterpart. (see Weislogel 1996) (see Weislogel 1998) Fundamentally showing that corner flow will produce a pronounced characteristic length and timely response.

TABLE 3
Weislogel corner flow system nondimensionalized
variables (Weislogel 1996)

| Lengths | Velocities | Other |
|---|---|---|
| x = x′/H | u = u′/ϵW | P = Hf P′/γ |
| y = y′/Htan(α) | v = v′/ϵWtan(α) | t = Wt′/L |
| yₘ = y′ₘₐₓ/Htan(α) | w = w′/W | \dot{Q} = \dot{Q}′/WH²tan(α) |
| z = z′/L | < w >=< w >′/W | A = A′/H²tan(α) |
| S = S′/H | W = ϵγsin²(α)/μf | < w >≡ \dot{Q}/A |
| h = h′/H | | |
| [symbol] = [symbol] ′/ L | | |

Table 3 presents a nondimensional approach to solving the corner flow problem while tying general characteristic interfacial dimensions from Equations 7 and 8 to height of meniscus respect to x-axis. As described herein in the nondimensional approach, primes are used to denote dimensional terms. Velocity terms incorporate geometry (with a) through balance of pressure and viscous forces. (see Weislogel 1996) To determine meniscus location along yz-plane and time, conditions of passive overlying film and no-slip are employed. Then Table 3 dimensionless parameters are passed through Navier-Stokes and continuity equations. Furthermore to supplement the analysis velocities, pressure, and meniscus location along yz-plane are asymptotically expended with a slenderness ratio as a basis. Resulting curvature of the interface described by magnitude of ƒ plays a role as capillary driving force as shown in Equation 9 and is dependent on α and θ which are coupled into δ, where δ≡π/2−α−θ. (see Weislogel 1996)

To proceed through the above steps conditions of symmetry around y=0 and constant curvature (R′=ƒh′, where R′ is dimensional radius of curvature) are used. Most importantly slender column and slight curvature conditions are both used and must be upheld during the design. Slight curvature in the x-axis is ensured when ϵ²ƒ<<1, while a slender column is defined as ϵ²<<1. (see Weislogel 1996) Such approach is complemented as slender column condition has also been employed for film profile flows in cases of rising film flow and for moving film acceleration, among others, that were also solved with Navier-Stokes regimen at low to moderate Reynold numbers. (see Kheshgi, H. S. Profile Equations for Film Flows at Moderate Reynolds Numbers. AlChE Journal 1989, 35 (10), 1719-1727)

$$f = {( \frac{sin ( δ + α )}{sin ( α )} - 1 )}^{- 1} \qquad ( 9 )$$

Where the sign of ƒ indicates the direction of driving force and therefore direction of flow at z-axis Such flow occurs through a cross sectional area that is governed by cross sectional area function which is geometrically derived and shown below. (see Weislogel 1996)

$${F}_{A} = \frac{{f}^{2} {sin}^{2} ( δ )}{tan ( α )} ( 1 - ( \frac{2 δ - sin ( 2 δ )}{1 - cos ( 2 δ )} ) - tan ( α ) ) \qquad ( 10 )$$

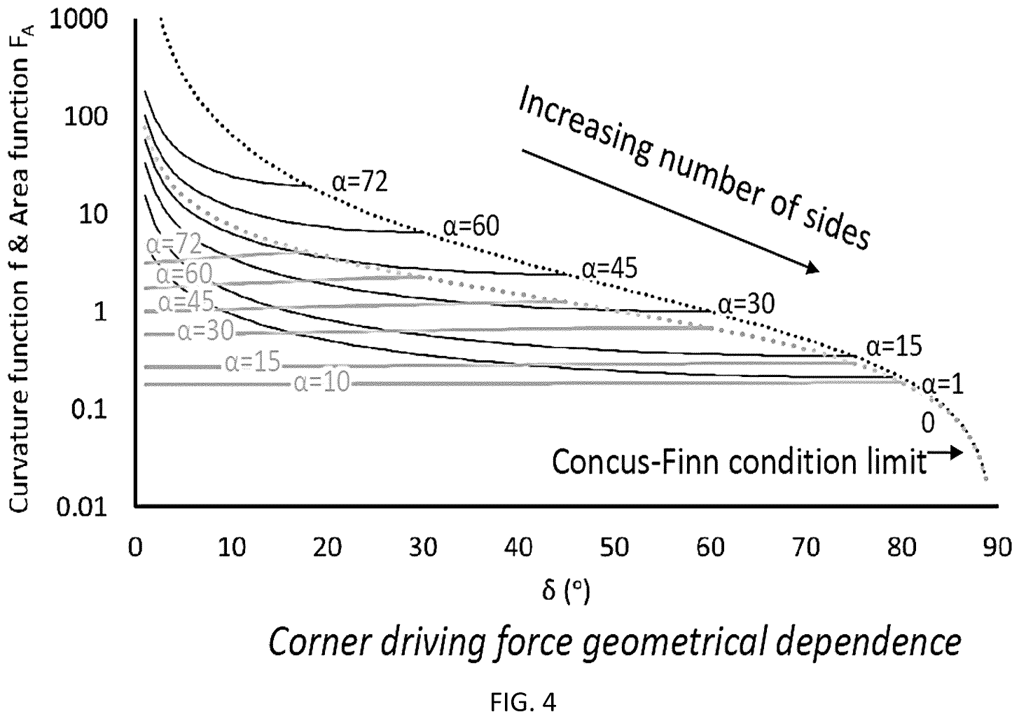

Noting that the function has a working range of 1≤F_{A}/tan(α)≲4/3, with the surface curvature function characterized as the driving force through its influence on pressure gradient for corner flow. Weislogel assembled a key design graph as shown in FIG. 4 for deciding corner angle. (see Weislogel 1996) Note that under the condition of θ=0 as considered herein the curvature parameter turns into δ≡π/2−α and adheres to Concus-Finn condition in range of 0<δ<π/2.

Resulting governing Equations 11 and 12 show velocity of liquid being dependent on the slope of meniscus. (see Weislogel 1996) With agreement with the above solving scheme and supported by experiments for a square capillary it should be noted that the velocity of liquid also scales with square root of tube size, \sqrt{D}. (see Dong 1995) More broadly Equations 11 and 12 structures also apply to unsteady-nonlinear heat flux through conduction. (see Mayer, F. J.; McGrath, J. F.; Steele, J. W. A Class of Similarity Solutions for the Nonlinear Thermal Conduction Problem. J. Phys. A: Math. Gen. 1983, 16 (14), 3393-3400)

$$\frac{\partial h}{\partial t} = {F}_{i} ( {( \frac{\partial h}{\partial t} )}^{2} \_ \frac{h}{2} \frac{{\partial }^{2} h}{\partial {z}^{2}} \qquad ( 11 )$$

$$\frac{\partial h}{\partial τ} = 2 {( \frac{\partial h}{\partial z} )}^{2} ( 1 + Bo {h}^{2} ) + h \frac{{\partial }^{2} h}{\partial {z}^{2}} ( 1 + Bo {h}^{2} ) \qquad ( 12 )$$

Conveniently meniscus height h(t, z) becomes the focal point of the governing equation while also being one of the key metrics aiding in indication. Banded flow resistance (Fᵢ) also emerges to play a role, as it been the focal point of numerical approach to solving such problems. To incorporate numerically solved solutions by Ransohoff-Radke of dimensionless flow resistance (β) and Ayyaswamy of dimensionless friction factor (K) one can utilize Equations 13 and 14 respectively:

$${F}_{1} = \frac{{f}^{2}}{β {sin}^{2} ( α )} \qquad ( 13 )$$

$${F}_{i} = \frac{8}{K} {( \frac{{F}_{A}}{f sin ( δ )} )}^{2} \qquad ( 14 )$$

Mathematical estimates through scaling of 2D Laplacian operators also exist for the banded friction factor in cases of rectangular, triangular, and trapezoidal cross section laminar flow with errors between 3% to 7%. (see Weislogel 2008) Supplementary banded friction factor asymptotic solutions exist for tan²(α)<<1, {(π/2−α)²<<1 & δ²<<1}, hydraulic diameter equivalence, θ=α=π/4, and {θ=π/3 & α=π/6}. (see Weislogel 1996) Both numerical data and analytical approaches have their conditions, so for original geometric design they may only serve as starting estimates that are refined through testing of such designs.

When bubbles are axisymmetric, their shape is independent of θ. Transition of bubbles symmetry is located at Ca˜0.1. (see Kolb, W. B.; Cerro, R. L. The Motion of Long Bubbles in Tubes of Square Cross Section*. Physics of Fluids A: Fluid Dynamics 1993, 5 (7), 1549-1557) Oh is the time scale ratio of restoring surface tension force to viscous. When high frequency disturbances are in question Oh can be a useful design metric, as Oh²<<1 systems would be underdamped and Oh²>>1 are damped through viscosity forces: (see Weislogel 1996)

$$C a ≡ \frac{μ W}{γ} \qquad ( 15 )$$

$$We ≡ \frac{ρ ( D / 2 ) {W}^{2}}{σ} \qquad ( 16 )$$

$$Oh = \sqrt{Ca / Re} = μ / \sqrt{ρ γ H} \qquad ( 17 )$$

Dimensionless Boussinesq viscosity (Bon) represents surface viscous dissipation. At small angles viscous forces become dominant. (see Ransohoff)

$$B {{o}_{η} ( \frac{{\partial }^{2} u}{\partial {θ}^{2}} )}_{ξ = 1} = {( \frac{\partial u}{\partial ξ} )}_{ξ = 1} \qquad ( 18 )$$

Design parameters include surface tension, viscosity, liquid density, number of wedges, radius of container, and height. Flow resistance is a function of surface viscosity, corner angle, contact angle, and corner roundness. Surface viscosity can increase flow resistance up to 4 times. Reducing surface flow area increases flow resistance, for example, a higher degree of corner roundness would result in increased flow resistance. (see Ransohoff) Smaller systems are less sensitive to inertia disturbances. In some embodiments, an additional inside curved wall is used to make it round while ensuring slender column condition.

A large reservoir would yield a set of solutions that trend to the likes of solutions for classic experiments of dipping a capillary tube end in a pool of liquid. In those experiments an infinite volume assumption can be applied, and results show that their magnitude changes. On the other hand going from infinite to finite volume also introduces geometry, and consequently any reservoir designed would function as a competing capillary. One approach to solving reservoir problem can be done in totality with equation presented herein, but it can also be broken into two problems. As a reservoir doesn't have to function as an indicator, therefore it is not limited to perfectly wetting gas/liquid/solid systems nor application of slender column requirement giving additional freedom of design. While at zero gravity the two capillary forces can be directly related to yield corner liquid length, but with gravity it must be considered against hydraulic pressure gradient introduced by gravity and therefore the reservoir location of connection. At the simplest case where large reservoir located at the bottom (closer to gravity center in relation to indicating surface) with large single spherical hydrophobic surface resulting liquid column length ought to match classical results mentioned above. This agrees with previously listed studies on friction factor suggesting that geometry and liquid: vapor ratio of herein discussed accelerometer container can be tailored for ease of interpretation for naked eye without a fundamental sacrifice of functionality as long as available surface area for liquid to climb on stays constant.

A key convenience is simplicity of such an indicator, in both use and potential manufacturing. The device can be outfitted with electric or optical sensors. Phenomena of surface tension balancing liquid and gas pressure can be miniaturized and is projected to work better at smaller scales.

Surface settling time is proportional to response time. In some embodiments, max response time from g to μg is about 4 sec.

$$Dimensionless : τ = \frac{{t}_{s} v}{{R}^{2}} f ( θ ) ∼ f ( ζ ) , g ( θ ) \qquad ( 19 )$$

$$Dimensional : {t}_{s} ∼ \frac{{R}^{2}}{v} {f ( θ )}^{- 1} [ {ζ}^{2} , g ( θ ) ] \qquad ( 20 )$$

In some embodiments, the oil comprises PDMS-EO diblock copolymer surfactant-poly (dimethyl siloxane-b-ethylene oxide) (bcp) 0.0 Conc. bcp mmol/L in water with 50/50 or 40/60 mass ratio with ethylene.

$${H}^{′} = \frac{D}{2 f} \frac{sin ( α + δ )}{{F}_{\overline{A}}} [ 1 - \sqrt{1 - \frac{{F}_{\overline{A}} cot ( π / N )}{{sin}^{2} ( α + δ )}} ] \qquad ( 21 )$$

Disturbances through inertia can break up a single gas phase bubble, which ought to be managed. This starts with ensuring a wetted surface to prevent bubbles from ‘sticking’ through a contact line and taking advantage of silicone anti-foaming properties. (see Aziz, T., et al. Modified Silicone Oil Types, Mechanical Properties and Applications. Polym. Bull. 2019, 76 (4), 2129-2145) Geometrically a design needs to avoid constriction in liquid path as snap off of gas threads (elongated bubble) can occur. (see Kovscek) None the less a case may arise if a device is large enough where two or more bubbles in local equilibrium positions are located at a distance from each other. While not an issue for the indicating surface in negligible gravity, a single gas bubble ought to be recovered once gravity is introduced. From a design perspective a corner flow geometry such as a smooth square capillary tube inherently aids in faster bubble transport through ensuring a thicker liquid film between the gas and solid surface. (see Bico, J.; Quéré, D. Rise of Liquids and Bubbles in Angular Capillary Tubes. Journal of Colloid and Interface Science 2002, 247 (1), 162-166) (see Bico, J.; Tordeux, C.; Quéré, D. Rough Wetting. EPL 2001, 55 (2), 214) In the case of a sealed square capillary filled with silicone oil experimental results show agreement with geometry adjusted Poiseuille law:

$${V}_{b} = ( 4.8 * 1 {0}^{- 5} {D}^{2} ρg ) / η \qquad ( 22 )$$

Where V_{b}, ρ, g, η is the bubble velocity, liquid density, gravitational acceleration, and liquid viscosity, respectively. This velocity of bubble can be zero when the liquid/gas interface doesn't have enough energy to deform from its ideal spherical shape to continue on. To gain intuition of when a bubble is trapped, refer to classical cylindrical capillary tube example solved by Bretherton. (see Bretherton, Francis Patton. The motion of long bubbles in tubes. Journal of Fluid Mechanics 1961, 10 (2) 166-188)

$$r < 0.918 {κ}^{- 1} \qquad ( 23 )$$

Where capillary length κ equals \sqrt{γ/ρg}. When the condition is met a bubble is stuck, but a more flexible general description of the bubble would be useful from design perspective. Kolb and Cerro related dimensionless parameters describing contributions from gravity, viscous and capillary forces (Equations 22-24) to a long asymmetric bubble film evolution for the case of downflow in square capillary tube. (see Kolb, W. B.; Cerro, R. L. The Motion of Long Bubbles in Tubes of Square Cross Section. Physics of Fluids A: Fluid Dynamics 1993, 5 (7), 1549-1557)

$$\frac{d P}{d z} = 8 π ( {R}_{s}^{2} - {R}_{s ∞}^{2} ) \frac{C a}{ψ ( {R}_{s} )} + ( 1 - \frac{ψ ( {R}_{s} )}{ψ ( {R}_{s ∞} )} ) B o \qquad ( 24 )$$

Where pressure gradient in z direction is described by dimensionless local flow coefficient (ψ) that is dependent on bubble radius Rₛ, or asymptotic bubble radius R_{s∞}. Solving for a local flow profile is shown by Kolb. (see Kolb, W. B.; Cerro, R. L. Film Flow in the Space between a Circular Bubble and a Square Tube. Journal of Colloid and Interface Science 1993, 159 (2), 302-311) Most importantly Equation 24 provides balance between capillary pressure, momentum and gravity from a gas bubble in a square capillary perspective while utilizing scalable dimensionless terms. (see Kolb 1993) Similar balance is seen in the above equations, but from a liquid perspective, ultimately the two perspectives have some area of agreement. For example, an insight into corner flow can be gained from Equation 24 by setting inside gas bubble reference pressure to zero, enabling one to relate pressure to curvature of meniscus that drives the corner flow.

In another embodiment, an accelerometer device for reduced gravity applications comprises an enclosed bounded volume forming an interior lumen having at least one solid surface; at least one fluid within the lumen; wherein the fluid includes particles in suspension; and wherein a least one of the fluid and particles in suspension possess an intrinsic material property responsive to gravity.

In one embodiment, the intrinsic material property responsive to gravity is surface energy in nature. In one embodiment, the intrinsic material property responsive to gravity is electrostatic in nature. In one embodiment, the solid, fluid and/or the suspension materials that form the gravity measurement system are dielectric in nature and the fluid contains particles of size range where surface-dominated electrostatic forces are greater than mass-proportional inertial forces favoring particle aggregation in proportion to reduced gravity environments. In one embodiment, the suspension is comprised of dielectric particles comprised of semiconducting quantum dot materials of nanoscale dimension whereby particle aggregation in reduced gravity environments promotes quenching of quantum dot photoluminescence.

In conclusion, corner flow indication of reduced gravity is fundamentally pronounced, quick and passive. Future overall designs have potential to be scaled down and integrated into digital systems. Future of indication surfaces can include wedges and fins, as groundwork already exists for such geometries. Most importantly a 360° indication surface design which doesn't require gyroscope body would be the ideal next step.

### EXPERIMENTAL EXAMPLES

The invention is now described with reference to the following Examples. These Examples are provided for the purpose of illustration only and the invention should in no way be construed as being limited to these Examples, but rather should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore, specifically point out exemplary embodiments of the present invention, and are not to be construed as limiting in any way the remainder of the disclosure.

A device similar to the device shown in FIG. 1 was prototyped. The motion of positioning the accelerometer to make a reading of gravity was done through a doubled wall transparent gyroscope body. Between the walls a transparent lubricant was placed to ease the motions. Once positioned the silicone oil was ready to start reaching its new equilibrium position to make the indication. In this prototype design the wall depth was 6.1 mm and column traveling length was 16 mm, and filling this chamber was Silicone oil of 5 cS in viscosity. Now if the accelerometer would enter free fall, as in a drop tower experiment, the unsteady state indication would be reached in approximately 2 seconds. This agrees with both herein presented theory and drop tower experimentation. Error between theory and experimentation is always below 10%. The 2 second mark is for liquid column first reaching its equilibrium height in an unsteady state, after which there may be oscillatory behavior damped by viscosity before reaching steady state at the 16 mm mark.

FIG. 2 is a plot showing general capillary characteristic geometric response (H) dependance on gravity in accordance with some embodiments. Note the high slope magnitude at reduced gravity, which is an ideal mechanism for reduced gravity applications.

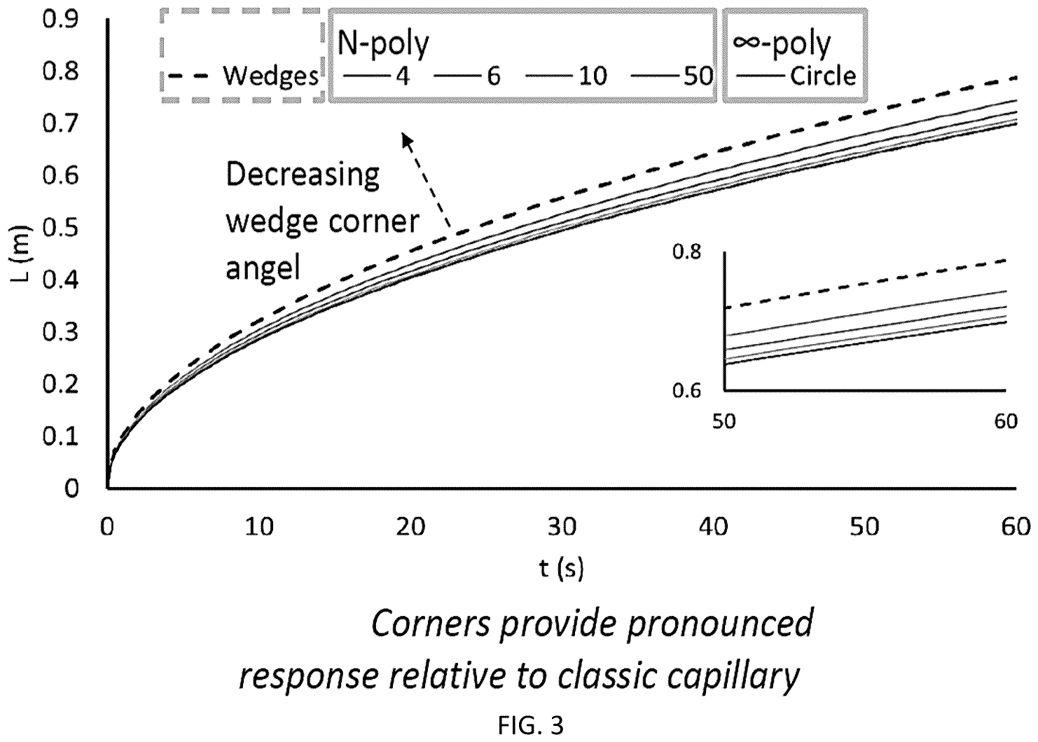

FIG. 3 is a plot showing that corners provide pronounced response relative to classic capillary action in accordance with some embodiments.

Initial geometrical flexibility is in variations on number of sides N was explored. The resulting cross sectional shape of the tube was symmetric in both axis and was a polygon due to current theoretical model requirements. Due to those constrictions, the number of sides in the current model controls the corner angle. As the number of corners increase the tube cross section becomes a circle resulting it becoming a classic capillary tube (FIG. 3). In the design stage the dimensional characteristic heigh under a constant height condition can be computed with Equation 25:

$${H}^{′} = \frac{D}{2 f} \frac{sin ( α + δ )}{{F}_{\overline{A}}} [ 1 - \sqrt{1 - \frac{{F}_{\overline{A}} cot ( π / N )}{{sin}^{2} ( α + δ )}} ] \qquad ( 25 )$$

Chamber shape dictates mean meniscus curvature (H) which is the driving force of the system playing a role in pressure balance. The 2-axis symmetry condition is derived from the use of mean curvature Equation 26, where Ω is cross sectional area, which an increase of would decrease curvature and therefore the driving force:

$$2 ℋ = \sqrt{\frac{N}{Ω}} ( \sqrt{tan ( \frac{N}{Ω} )} cos ( θ ) + \sqrt{sin ( γ ) cos ( γ ) + \frac{π}{N} - γ} ) \qquad ( 26 )$$

When N reaches infinity Equations 25-26 describe a capillary tube. In that case the average meniscus curvature can simplified and described by Equation 27:

$$2 ℋ = 2 cos ( θ ) / r \qquad ( 27 )$$

FIG. 3 compares the liquid column length over time in a case of an infinite reservoir showing indication benefit of using corners rather than a circular tube. An example of assumed liquid behavior in wedges is also shown, currently wedges are not fully integrated into theoretical model but some groundwork has been done, enough to demonstrate possible benefit of utilizing them. To illustrate the benefit an infinite reservoir case was chosen to check against well understood capillary rise in a circular tube that has been historically conducted by dipping a long capillary column into a large pool.

While comparison to a classic capillary device is done to show inherent advantage of how corners are beneficial, what is of more interests is the time response of liquid under a constant volume. Modeling for liquid settling in its new equilibrium position upon a step change in acceleration is described in Equations 28-29 in both dimensionless and dimensional and forms, where the latter has been constructed via empirical correlation:

$$τ = \frac{2 {t}_{s} μ}{{r}^{2}} \qquad ( 28 )$$

$${t}_{s} ∼ \frac{{r}^{2}}{2 μ} ( 46.99 {μ}^{1.28} \sqrt{\frac{ρ}{r γ}} + 0.01 ) \qquad ( 29 )$$

The above equations apply strictly to cylindrical container with no corners and with total wetting (θ=0), but it does provide an insight into response time for cornered designs. Insight is gained because a corner design is amplified relative to cylindrical design as seen in FIG. 3 without changing nature of the response.

The characteristic response in show in FIG. 2 as a function of square root of surface tension divided by density and gravity. The basis for the characteristic response was Polydimethylsiloxane (PDMS, silicone oil) provided by Dow Corning at μ=5 sC, ρ_{I}=913 kg/m³, and γ=0.0197 N/m. Other than specific materials used, the point of FIG. 2 is to show that a corner flow accelerometer would be inherently sensitive to gravity once its reduced. This is an example of characteristic heigh scaling with capillary length. To gain more specific insight into liquid length response (dimensional along z-axis) rather than the general characteristic (dimensionless along x-axis) one can refer to Weislogel and Litcher similarity solutions. Similarity solutions are derived from governing Equation 11, and with the enforcement of a constant volume condition and at step change to negligible gravity at t=0, result is shown in Equation 30 below. To get a visual on how Equation 30 applies refer to the drop tower experiments conducted by Wieslogel and Litcher.

$$ℒ = 1. 879 {{F}_{A}^{- 1 / 5} [ γ {F}_{i} {sin}^{2} ( α / μ f ) ]}^{2 / 5} {H}^{3 / 5} {t}^{2 / 5} \qquad ( 30 )$$

The results of Wieslogel and Litcher show displacement of meniscus between an initially flat and steady state, as well as a damping effect of increased viscosity, where low viscosities show oscillatory behavior before reaching steady state and high viscosities are over damped and require additional time to converge to steady state value.

Upon a step change in gravity the surface will settle into new equilibrium position, but if gravity is negligible the solutions for a semi-infinite column don't converge. For a finite column at negligible gravity the fluid will climb to the roof of the chamber and then distribute itself in corners perpendicular to the z-axis. Conclusively the liquid will isolate the gas away from the walls. So for negligible gravity it is also worthwhile to visit this problem from the perspective of gas bubbles.

Disturbances through inertia can break up a single gas phase bubble, which ought to be managed. This starts with ensuring a wetted surface to prevent bubbles from ‘sticking’ through a contact line and taking advantage of silicone anti-foaming properties.^{[94]} Geometrically a design needs to avoid constriction in liquid path as snap off of elongated bubble can occur.^{[84]} None of the less a case may arise if device is large enough where two or more bubbles in local equilibrium positions are located at a distance from each other. While not an issue for the indicating surface in negligible gravity, a single gas bubble ought to be recovered once gravity is introduced. From design perspective a corner flow geometry such as a smooth square capillary tube inherently aid faster bubble transport through ensuring a thicker liquid film between the gas and solid surface.^{[83, 95]} In the case of sealed square capillary filled with silicone oil experimental results show agreement with geometry adjusted Poiseuille law as described in Equation 22.

Design control parameters from the above model have been identified to be the surface tension of liquid, density, viscosity, reduced surface viscosity, and then dimensions of chamber such as corner angles, side lengths, and height. Contact angle has not been included in the list due to utilization of perfectly wetted condition. Such condition allows one to skip calculation of a moving contact line, and that contact line interacting with heterogenous surface of the wall. A homogenous surface in principle could be applied and a contact angle applied as additional control parameters but such requirements would place a burden on a manufacturer which then would be passed onto a user via increased price tag. Furthermore, upkeep of a homogenous surface would add an additional burden of maintenance and reduce lifetime of the accelerometer. A moving contact line would also expose the surface to trapping bubbles. On the other hand, with total wetting there is both more theory available and more empirical experiments to rely on. To satisfy both total wetting condition and low costs it was decided to utilize an acrylic chamber with silicon oil.

While silicon oil is used its surface tension can be manipulated with additives such as surfactants. Surface tension enforces equilibrium curvature of meniscus as shown in Equation 26 for average meniscus curvature. This parameter also directly feeds into the Bond number, which is also present in governing Equation 26. Increasing surface tension increases equilibrium position height of the liquid and vice versa. Ultimately surface tension works against gravity. On the other hand of the conversation is density, working along with gravity due to gravity acting on mass. Both work to establish a pressure gradient that ultimately dictates the equilibrium condition. Surface tension of the solid is not included because of total wetting.

Viscosity plays a key role in damping of the liquid location response, where increasing viscosity increases the degree of damping. While reduced surface viscosity, otherwise known as Boussinesq surface, shear viscosity is needed for dimensionless approach to the problem.

Corner angle, here controlled with number of side N, is a key metric. FIG. 4 shows how corner angle directly effects both curvature and cross-sectional flow area function. Curvature governs response strength and cross sectional area governs response speed, as higher cross sectional area allows for larger flow rates along the channel. This is not only key for the system but also for the accelerometer's ability to indicate, since the indication is done through viewing liquid column length. In this body of work possible corner angle increments are locked in by a N-sided polygon that has 2-axis of symmetry condition, but future improvements to a model of liquid curvature will allow for more flexibility. This is not a distant dream since groundwork for wedges, rounded corners, and fins and other non-regular shapes already exists.

Length of the channel would dictate indication distance. Keeping everything else constant an increased length would allow for enhanced reduced gravity indication. Along with wall depth (wall length measured from corner to corner) the two parameters dictate the size of accelerometer. An increase of size the accelerometer would lead to more inertia governed, while a decrease in size would result in surface forces to become more dominant.

FIG. 4 is a plot showing corner driving force geometrical dependence in accordance with some embodiments. Both curvature (ƒ) and cross-sectional flow functions (F_{A}) for varying corner geometries from top to bottom of α=72°, 60°, 45°, 30°, 15°, and 10°. With dotted lines showing limits of both functions due to conditions used. (see Weislogel 1996)

### Computing Environment

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C#, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

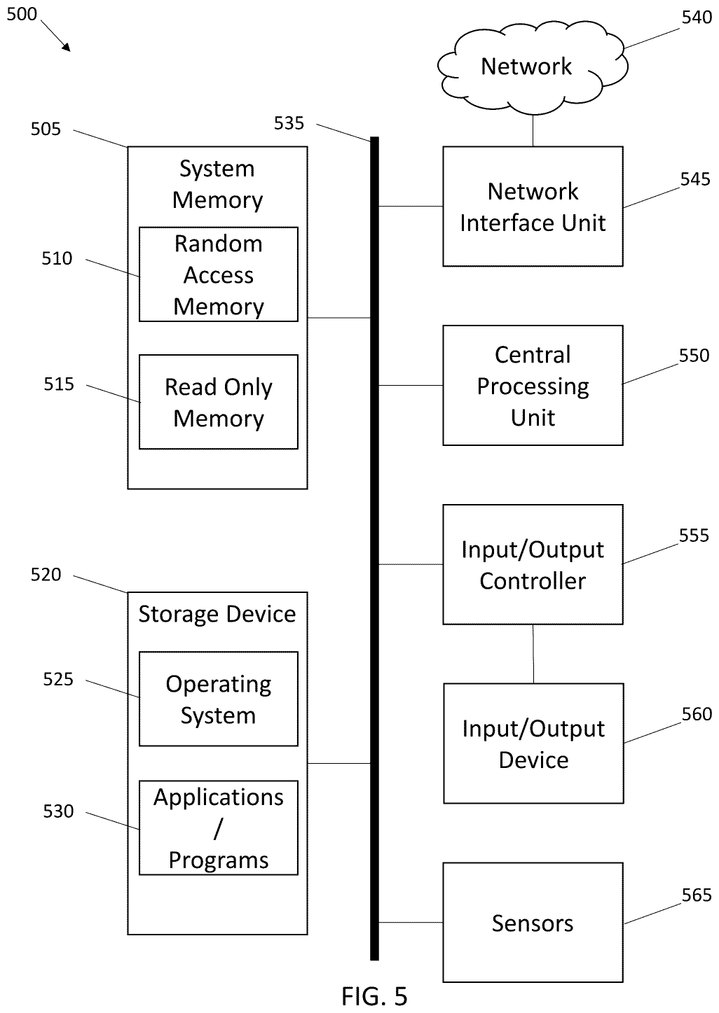

FIG. 5 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 5 depicts an illustrative computer architecture for a computer 500 for practicing the various embodiments of the invention. The computer architecture shown in FIG. 5 illustrates a conventional personal computer, including a central processing unit 550 (“CPU”), a system memory 505, including a random-access memory 510 (“RAM”) and a read-only memory (“ROM”) 515, and a system bus 535 that couples the system memory 505 to the CPU 550. A basic input/output system containing the basic routines that help to transfer information between elements within the computer, such as during startup, is stored in the ROM 515. The computer 500 further includes a storage device 520 for storing an operating system 525, application/program 530, and data.

The storage device 520 is connected to the CPU 550 through a storage controller (not shown) connected to the bus 535. The storage device 520 and its associated computer-readable media, provide non-volatile storage for the computer 500. Although the description of computer-readable media contained herein refers to a storage device, such as a hard disk or CD-ROM drive, it should be appreciated by those skilled in the art that computer-readable media can be any available media that can be accessed by the computer 500.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 500 may operate in a networked environment using logical connections to remote computers through a network 540, such as TCP/IP network such as the Internet or an intranet. The computer 500 may connect to the network 540 through a network interface unit 545 connected to the bus 535. It should be appreciated that the network interface unit 545 may also be utilized to connect to other types of networks and remote computer systems.

The computer 500 may also include an input/output controller 555 for receiving and processing input from a number of input/output devices 560, including a keyboard, a mouse, a touchscreen, a camera, a microphone, a controller, a joystick, or other type of input device. Similarly, the input/output controller 555 may provide output to a display screen, a printer, a speaker, or other type of output device. The computer 500 can connect to the input/output device 560 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 520 and RAM 510 of the computer 500, including an operating system 525 suitable for controlling the operation of a networked computer. The storage device 520 and RAM 510 may also store one or more applications/programs 530. In particular, the storage device 520 and RAM 510 may store an application/program 530 for providing a variety of functionalities to a user. For instance, the application/program 530 may comprise many types of programs such as a word processing application, a spreadsheet application, a desktop publishing application, a database application, a gaming application, internet browsing application, electronic mail application, messaging application, and the like. According to an embodiment of the present invention, the application/program 530 comprises a multiple functionality software application for providing word processing functionality, slide presentation functionality, spreadsheet functionality, database functionality and the like.

The computer 500 in some embodiments can include a variety of sensors 565 for monitoring the environment surrounding and the environment internal to the computer 500. These sensors 565 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

The following references are each include herein by reference in their entirety:
Concus, P.; Finn, R. On the behavior of a capillary surface in a wedge*. Proc Natl Acad Sci USA 1969, 63 (2), 292-299.
Ayyaswamy, P. S.; Catton, I.; Edwards, D. K. Capillary Flow in Triangular Grooves. Journal of Applied Mechanics 1974, 41 (2), 332-336. https://doi.org/10.1115/1.3423288.
Ransohoff, T. C.; Radke, C. J. Laminar Flow of a Wetting Liquid along the Corners of a Predominantly Gas-Occupied Noncircular Pore. Journal of Colloid and Interface Science 1988, 121 (2), 392-401. https://doi.org/10.1016/0021-9797(88)90442-0.
Dong, M.; Chatzis, I. The Imbibition and Flow of a Wetting Liquid along the Corners of a Square Capillary Tube. Journal of Colloid and Interface Science 1995, 172 (2), 278-288. https://doi.org/10.1006/jcis.1995.1253.
Kovscek, A. R.; Radke, C. J. Gas Bubble Snap-off under Pressure-Driven Flow in Constricted Noncircular Capillaries. Colloids and Surfaces A: Physicochemical and Engineering Aspects 1996, 117 (1), 55-76. https://doi.org/10.1016/0927-7757(96)03637-0.
Weislogel, M. M. Capillary Flow in an Interior Corner, NASA Technical Memorandum 107364, 1996.
Weislogel, M. M.; Lichter, S. Capillary Flow in an Interior Corner. Journal of Fluid Mechanics 1998, 373, 349-378. https://doi.org/10.1017/S0022112098002535.
Ramé, E.; Weislogel, M. M. Gravity Effects on Capillary Flows in Sharp Corners. Physics of Fluids 2009, 21 (4), 042106. https://doi.org/10.1063/1.3109685.
Kellman, J. Discovery and Enlightenment at Sea: Maritime Exploration and Observation in the 18th-Century French Scientific Community. Ph.D., Princeton University, United States—New Jersey.
Turner, A. J. Melchisedech Thevenot, The Bubble Level, and The Artificial Horizon. Nuncius 1992, 7 (1), 131-145. https://doi.org/10.1163/182539192X00064.
Space Vehicle Accelerometer Applications. National Aeronautics and Space Administration, NASA SP-812, December 1972.
Patton Downey, J. Microgravity Materials ISS Mini Book 508c2. NASA ISS Program Science Office. p 48.
Hockert, C.; Eason, L. P.; Harris, G. L.; Miller, V. R. Specifications and Tolerances for Reference Standards and Field Standard Weights and Measures, 2010.
Volfson, L.; Starodubov, D. Fiber Optic Manufacturing in Space. US20170233282A1, Aug. 17, 2017.
Dubbs, C. Realizing Tomorrow the Path to Private Spaceflight; Outward odyssey; University of Nebraska Press: Lincoln, 2011.
Bico, J.; Quéré, D. Rise of Liquids and Bubbles in Angular Capillary Tubes. Journal of Colloid and Interface Science 2002, 247 (1), 162-166. https://doi.org/10.1006/jcis.2001.8106.
Cantat, I.; Kern, N.; Delannay, R. Dissipation in Foam Flowing through Narrow Channels. EPL 2004, 65 (5), 726. https://doi.org/10.1209/epl/i2003-10169-0.
Aziz, T.; Fan, H.; Khan, F. U.; Haroon, M.; Cheng, L. Modified Silicone Oil Types, Mechanical Properties and Applications. Polym. Bull. 2019, 76 (4), 2129-2145. https://doi.org/10.1007/s00289-018-2471-2.
Bico, J.; Tordeux, C.; Quéré, D. Rough Wetting. EPL 2001, 55 (2), 214. https://doi.org/10.1209/epl/i2001-00402-x.
Kolb, W. B.; Cerro, R. L. The Motion of Long Bubbles in Tubes of Square Cross Section*. Physics of Fluids A: Fluid Dynamics 1993, 5 (7), 1549-1557. https://doi.org/10.1063/1.858832.
Bretherton, Francis Patton. The motion of long bubbles in tubes. Journal of Fluid Mechanics 1961, 10 (2) 166-188.
Kolb, W. B.; Cerro, R. L. Film Flow in the Space between a Circular Bubble and a Square Tube. Journal of Colloid and Interface Science 1993, 159 (2), 302-311. https://doi.org/10.1006/jcis.1993.1327.
Young, T. An Essay on the Cohesion of Fluids. Philosophical Transactions of the Royal Society of London 1805, 95, 65-87.
Gibbs, J. W. Scientific Papers of J. Willard Gibbs; Dover Publications, [1961]: New York, 1961; Vol. 1.
Whyman, G.; Bormashenko, E.; Stein, T. The Rigorous Derivation of Young, Cassie-Baxter and Wenzel Equations and the Analysis of the Contact Angle Hysteresis Phenomenon. Chemical Physics Letters 2008, 450 (4-6), 355-359. https://doi.org/10.1016/j.cplett.2007.11.033.
Roura, P.; Fort, J. Local Thermodynamic Derivation of Young's Equation. Journal of Colloid and Interface Science 2004, 272 (2), 420-429. https://doi.org/10.1016/j.jcis.2004.01.028.
Makkonen, L. Young's Equation Revisited. J. Phys.: Condens. Matter 2016, 28 (13), 135001. https://doi.org/10.1088/0953-8984/28/13/135001.
Hawa, T.; Zachariah, M. R. Internal Pressure and Surface Tension of Bare and Hydrogen Coated Silicon Nanoparticles. The Journal of chemical physics 2004, 121 (18), 9043-9049. https://doi.org/10.1063/1.1797073.
Wang, E. N.; Chu, K.-H.; Xiao, R. Uni-Directional Liquid Spreading on Asymmetric Nanostructured Surfaces. Nature materials 2010, 9 (5), 413-417. https://doi.org/10.1038/nmat2726.
Demirel, M. C.; Malvadkar, N. A.; Hancock, M. J.; Sekeroglu, K.; Dressick, W. J. An Engineered Anisotropic Nanofilm with Unidirectional Wetting Properties. Nature materials 2010, 9 (12), 1023-1028. https://doi.org/10.1038/nmat2864.
Liu, Y.; Wang, J.; Zhang, X.; Wang, W. Contact Line Pinning and the Relationship between Nanobubbles and Substrates. J. Chem. Phys. 2014, 140 (5), 054705. https://doi.org/10.1063/1.4863448.
Ababneh, A.; Amirfazli, A.; Elliott, J. a. W. Effect of Gravity on the Macroscopic Advancing Contact Angle of Sessile Drops. The Canadian Journal of Chemical Engineering 2006, 84 (1), 39-43. https://doi.org/10.1002/cjce.5450840107.
Diana, A.; Castillo, M.; Brutin, D.; Steinberg, T. Sessile Drop Wettability in Normal and Reduced Gravity. Microgravity Sci. Technol. 2012, 24 (3), 195-202. https://doi.org/10.1007/s12217-011-9295-0.
Zhu, Z.-Q.; Wang, Y.; Liu, Q.-S.; Xie, J.-C. Influence of Bond Number on Behaviors of Liquid Drops Deposited onto Solid Substrates. Microgravity Sci. Technol. 2012, 24 (3), 181-188. https://doi.org/10.1007/s12217-011-9294-1.
Calvimontes, A. The Measurement of the Surface Energy of Solids by Sessile Drop Accelerometry. Microgravity Sci. Technol. 2018, 30 (3), 277-293. https://doi.org/10.1007/s12217-018-9596-7.
Allen, J. S. An Analytical Solution for Determination of Small Contact Angles from Sessile Drops of Arbitrary Size. Journal of Colloid and Interface Science 2003, 261 (2), 481-489. https://doi.org/10.1016/S0021-9797(03)00127-9.
Kistler, S. F. Hydrodynamics of wetting. In Wettability (ed. J. C. Berg), Surfactant Science Series 1993, vol. 49, 311-429.
Dussan, E. B. On the Spreading of Liquids on Solid Surfaces: Static and Dynamic Contact Lines. Annual review of fluid mechanics 1979, 11 (1), 371-400. https://doi.org/10.1146/annurev.fl.11.010179.002103.
Hu, X. Y.; Adams, N. A. Moving Contact Line with Balanced Stress Singularities. arXiv: 0806.3847 [physics] 2008.
Sheng, Y.-J.; Jiang, S.; Tsao, H.-K. Effects of Geometrical Characteristics of Surface Roughness on Droplet Wetting. J. Chem. Phys. 2007, 127 (23), 234704. https://doi.org/10.1063/1.2804425.
Concus, P. & Finn, R. 1990 Capillary surfaces in microgravity. In Low-Gravity Fluid Dynamics and Transport Phenomena. (ed. J. N. Koster & R. L. Sani). Progress in Astronautics and Aeronautics, Vol. 130, pp. 183-204. AIAA.
Mason, G. & Morrow, N. 1991 Capillary behavior of a perfectly wetting liquid in irregular triangular tubes. J. Colloid Interface Sci. 141, 262-274.
Langbein, D. 1990 The shape and stability of liquid menisci at solid edges. J. Fluid Mech. 213, 251-265.
Wong, H., Morris, S. & Radke, C. J. 1992 Three-dimensional menisci in polygonal capillaries. J. Colloid Interface Sci. 148, 317-336.
Ransohoff, T. C., Gauglitz, P. A. & Radke, C. J. 1987 Snap-off of gas bubbles in smoothly constricted noncircular capillaries. AIChE J. 33, 753-765.
Dong, M. & Chatzis, I. 1995 The imbibition and flow of a wetting liquid along the corners of a square capillary tube. J. Colloid Interface Sci. 172, 278-288.
Weislogel, M. M. Capillary Flow in an Interior Corner, 1996.
Concus, P.; Finn, R. On Capillary Free Surfaces in a Gravitational Field. Acta Mathematica 1974, 132 (none), 207-223. https://doi.org/10.1007/BF02392115.
Concus, P.; Finn, R. On Capillary Free Surfaces in the Absence of Gravity. Acta Mathematica 1974, 132 (none), 177-198. https://doi.org/10.1007/BF02392113.
Weislogel, M. Capillary Flow in Containers of Polygonal Section: Theory and Experiment. Theory and Experiment 2001, 26.
Weislogel, M. M. Capillary Flow in Interior Corners: The Infinite Column. Physics of Fluids 2001, 13 (11), 3101-3107. https://doi.org/10.1063/1.1408918.
Chen, Y.; Weislogel, M. M.; Nardin, C. L. Capillary-Driven Flows along Rounded Interior Corners. Journal of Fluid Mechanics 2006, 566, 235-271. https://doi.org/10.1017/S0022112006001996.
Weislogel, M. M.; Chen, Y.; Bolleddula, D. A Better Nondimensionalization Scheme for Slender Laminar Flows: The Laplacian Operator Scaling Method. Physics of Fluids 2008, 20 (9), 093602. https://doi.org/10.1063/1.2973900.
Weislogel, M. M. Compound Capillary Rise. Journal of Fluid Mechanics 2012, 709, 622-647. https://doi.org/10.1017/jfm.2012.357.
Weislogel, M. M.; Ross, H. D. Surface Settling in Partially Filled Containers upon Step Reduction in Gravity, 1990.
Concus, P.; Finn, R.; Weislogel, M. Measurement of Critical Contact Angle in a Microgravity Space Experiment. Experiments in Fluids 2000, 28 (3), 197-205. https://doi.org/10.1007/s003480050379.
Mayer, F. J.; McGrath, J. F.; Steele, J. W. A Class of Similarity Solutions for the Nonlinear Thermal Conduction Problem. J. Phys. A: Math. Gen. 1983, 16 (14), 3393-3400. https://doi.org/10.1088/0305-4470/16/14/031.
Kheshgi, H. S. Profile Equations for Film Flows at Moderate Reynolds Numbers. AlChE Journal 1989, 35 (10), 1719-1727. https://doi.org/10.1002/aic.690351017.
Santoli, F.; Fiorenza, E.; Lefevre, C.; Lucchesi, D. M.; Lucente, M.; Magnafico, C.; Morbidini, A.; Peron, R.; lafolla, V. ISA, a High Sensitivity Accelerometer in the Interplanetary Space. Space Sci Rev 2020, 216 (8), 145. https://doi.org/10.1007/s11214-020-00768-6.
Erk K A, Martin J D, Schwalbe J T, Phelan F R, Hudson S D. Shear and dilational interfacial rheology of surfactant-stabilized droplets. Journal of Colloid and Interface Science. 2012 Jul. 1; 377 (1): 442-9.
Liu Yong-Ming Wu Zi-Qing Bao Sheng Guo Wei-Hong Li Da-Wei He Jin Zeng Xiang-Bin Huang Lin-Jun Lu Qin-Qin Guo Yun-Zhu et al., The Possibility of Changing the Wettability of Material Surface by Adjusting Gravity. Research. 2020:2020; DOI: 10.34133/2020/2640834
Love, S. G., Pettit, D. R. and Messenger, S. R. (2014), Particle aggregation in microgravity: Informal experiments on the International Space Station. Meteorit Planet Sci, 49:732-739. https://doi.org/10.1111/maps.12286
Carter, W. E., et al. (1994), New gravity meter improves measurements, Eos Trans. AGU, 75 (8), 90-92, doi: 10.1029/94EO00542.
Chapin, D, “Gravity instruments; past, present, future,” The Leading Edge, Jan. 1, 1998
U.S. Pat. No. 2,303,845, Titled “Apparatus for the measurement of gravity”, filed Nov. 15, 1937
Marson and J E Faller; “g-the acceleration of gravity: its measurement and its importance”, 1986 J. Phys. E: Sci. Instrum. 19 22
Trudel G, Shafer J, Laneuville O, Ramsay T. Characterizing the effect of exposure to microgravity on anemia: more space is worse. Am J Hematol. 2020 March; 95 (3): 267-273. doi: 10.1002/ajh.25699. Epub 2019 Dec. 24. PMID: 31816115.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

1. An accelerometer device for reduced gravity applications, comprising:
a sealed capillary tube having a first end and a second end and a length therebetween, the capillary tube forming an interior lumen comprising at least one interior surface;
wherein the capillary tube is partially filled with a capillary fluid; and
wherein the capillary tube includes at least one corner running along at least a portion of the length at the edge of the at least one interior surface configured to enhance capillary flow.

2. The device of claim 1, wherein the at least one corner is at the intersection between two or more interior surfaces.

3. The device of claim 1, wherein the capillary tube is anchored to a weight inside a gyroscope body.

4. The device of claim 1, wherein the capillary tube is transparent or translucent, and wherein the interior surface comprises an indication surface.

5. (canceled)

6. The device of claim 1, further comprising at least one wedge or fin affixed to the interior surface.

7. The device of claim 1, wherein the at least one corner is in the range of 1 to 1000 corners.

8. The device of claim 1, wherein the capillary tube comprises an n-gonal prism, a square prism, a rectangular prism, a triangular prism, a pentagonal prism, a hexagonal prism, an octagonal prism, a trapezoidal prism, or a polygonal prism.

9. The device of claim 1, wherein a cross-section of the lumen of the capillary tube comprises a square, rectangle, parallelogram, diamond, trapezoid, trapezium, rhombus, triangle, curvilinear triangle, tear drop, crescent, pentagon, or polygon.

10. The device of claim 1, wherein the capillary fluid comprises a polar liquid comprising water or ethanol, or a non-polar liquid comprising silicone oil.

11. The device of claim 1, wherein the capillary fluid comprises a volume of 1 pL to 1000 mL.

12. The device of claim 1, wherein the capillary tube comprises at least one of a ceramic with high intrinsic wetting characteristics, a glass ceramic that has tunable wetting characteristics, borosilicate glass, titanium dioxide, silica, a polymer with high intrinsic wetting characteristics, a polymer that has tunable wetting characteristics, acrylics, epoxies, polyethylene, polystyrene, polyvinylchloride, polytetrafluorethylene, polydimethylsiloxane, polyesters, and polyurethanes.

13. The device of claim 1, wherein the capillary tube has a length in the range of 1 μm to 50 m, a width in the range of 1 nm to 1 m, a height in the range of 1 nm to 1 m, and an interior volume in the range of 1 μL to 10 L.

14. An accelerometer system for reduced gravity applications, comprising:
an accelerometer device comprising:
a sealed capillary tube having a first end and a second end and a length therebetween, the capillary tube forming an interior lumen comprising at least one interior surface,
wherein the capillary tube is partially filled with a capillary fluid, and
wherein the capillary tube includes at least one corner running along at least a portion of the length at the edge of the at least one interior surface configured to enhance capillary flow;
at least one sensor proximate to the accelerometer device configured to measure a fluid height or meniscus curvature due to capillary flow in the accelerometer device; and
a computing system communicatively connected to the at least one sensor, comprising a processor and a non-transitory computer-readable medium with instructions stored thereon, which when executed by the processor, perform steps comprising:
calculating a dimensionless Bond number based on the measured fluid height or meniscus curvature, wherein the dimensionless Bond number comprises a ratio between gravitational and surface forces; and
calculating a gravitational force based on the Bond number.

15. The system of claim 14, wherein the at least one sensor comprises an electrical or optical sensor.

16. The system of claim 14, wherein the system is configured to measure a gravitational acceleration force in the range of 0 g to 5 g where g equals 9.8 m/sec².

17. A gravitational acceleration monitoring method, comprising:
an accelerometer device comprising:
a sealed capillary tube having a first end and a second end and a length therebetween, the capillary tube forming an interior lumen comprising at least one interior surface,
wherein the capillary tube is partially filled with a capillary fluid, and
wherein the capillary tube includes at least one corner running along at least a portion of the length at the edge of the at least one interior surface configured to enhance capillary flow;
measuring a fluid height or meniscus curvature due to capillary flow;
calculating a dimensionless Bond number based on the measured fluid height or meniscus curvature, wherein the dimensionless Bond number comprises a ratio between gravitational and surface forces; and
calculating a gravitational force based on the Bond number.

18. The method of claim 17, wherein the fluid height or meniscus curvature is measured via at least one sensor proximate to the corner flow accelerometer device, and wherein the at least one sensor comprises an electrical or optical sensor.

19. (canceled)

20. The method of claim 17, wherein the Bond number is defined by
$${B}_{0} = \frac{ρ g {H}^{2}}{σ} ,$$
where ρ is the density, g is the gravitational acceleration, H is the characteristic meniscus height, and σ is the surface tension.

21. An accelerometer device for reduced gravity applications, comprising:
an enclosed bounded volume forming an interior lumen having at least one solid surface;
at least one fluid within the lumen;
wherein the fluid includes particles in suspension; and
wherein a least one of the fluid and particles in suspension possess an intrinsic material property responsive to gravity.

22. The device of claim 21, wherein the intrinsic material property responsive to gravity is surface energy or electrostatic in nature.

23. (canceled)
